(19) United States
(12) Patent Application Publication
(10) Pub. No.: US 2025/0353452 A1
(43) Pub. Date: Nov. 20, 2025

(54) COLLAPSIBLE HARNESS SUBSTRATES WITH EMBEDDED CHANNELS FOR OPTIMIZED POSITIONING OF ELECTRICAL WIRING HARNESSES

(71) Applicant: GM GLOBAL TECHNOLOGY OPERATIONS LLC, Detroit, MI (US)

(72) Inventors: Mark A. Smith, Huntington Woods, MI (US); Brian J. Haase, Warren, MI (US); Robert J. Kliffel, Farmington Hills, MI (US); Matthew D. Bush, Rochester Hills, MI (US); Joseph A. Mears, North Branch, MI (US); Lynn M. Potts, Sterling Heights, MI (US); Vahidreza Molazadeh, Royal Oak, MI (US)

(73) Assignee: GM GLOBAL TECHNOLOGY OPERATIONS LLC, Detroit, MI (US)

(21) Appl. No.: 18/665,881

(22) Filed: May 16, 2024

(51) Int. Cl. B60R 16/02

(52) U.S. Cl. CPC B60R 16/0215

(57) ABSTRACT

Presented are collapsible harnesses substrate systems for optimized positioning of electrical wiring harnesses, methods for making/using such harness substrate systems, and motor vehicles assembled using such harness substrate systems. A wiring harness substrate system includes a wiring harness with multiple electrical connectors, multiple cable segments electrically interconnected with the electrical connectors, and optional junctions, relays, embedded sensors, etc. A collapsible harness substrate supports thereon the wiring harness, e.g., to optimize storage, shipping, unpacking, and installation of the harness. Integrally formed with or attached to the harness substrate are a distributed array of holding features and a network of interconnected cable channels. The holding features releasably secure the electrical connectors and the cable segments to the harness substrate, whereas the cable channels receive therein and route the cable segments across the harness substrate. The collapsible harness substrate is designed to be selectively transitioned between an expanded state and a packed state.

### INTRODUCTION

The present disclosure relates generally to electrical cable systems. More specifically, aspects of this disclosure relate to systems and methods for aligning a wiring harness with a vehicle underbody during installation of the harness to the vehicle.

Current production motor vehicles, such as the modern-day automobile, are originally equipped with a network of onboard controllers, sensors, communications devices, vehicle accessories, and assorted other electronic components that are distributed across the vehicle body. A resident electrical system governs the transfer of electrical signals between the vehicle's individual electronic components as well as the distribution of electrical power to these components from a rechargeable energy storage system (RESS) that supplies the requisite power for operating the vehicle. Many vehicular electrical systems use an electrical wiring harness (also referred to as “cable harness”) to interconnect the vehicle's distributed array of electrical components and subsystems. Traditional automobiles used discrete electrical wires that were individually routed across the vehicle body and coupled one-by-one to the vehicle's electrical components. Contemporary computer-based vehicles, on the other hand, employ a wiring harness that bundles the interconnecting wires, connectors, junctions, relays, embedded sensors, etc., into a single modular assembly that simplifies the packaging and connection process.

With the continued development and deployment of autonomous and electric-drive vehicles that contain complex electronics, power, and controls systems, the manufacturing procedures needed to operatively interconnect these systems have become increasingly complicated tasks. To facilitate such interconnections, manufacturers are now using a multi-headed wiring harnesses with a central harness network composed of insulated and bundled wire segments, and numerous connection receptacle “heads” that extend from opposing sides and ends of the central harness network and locate throughout the vehicle body and frame. These wiring harnesses may have multiple sections, cross-connections, receptacles, and connectors. In such instances, installation of the wiring harness may entail tedious, time-consuming unfolding, flipping, and precise alignment in order to properly orient all of the various sections for packaging onto the vehicle.

### SUMMARY

Presented below are collapsible harnesses substrate systems with embedded channels for optimized positioning of electrical wiring harnesses, methods for making and methods for using such harness substrate systems, and motor vehicles assembled using such harness substrate systems. Vehicle wiring harnesses are typically presented to assemblers in a jumbled pile of wire bundles, requiring a long and tedious process of identifying the individual sections of the harness, unfolding and flipping the harness, then pulling the harness sections to their target positions on the vehicle body/chassis. To optimize the harness unpacking and positioning process, systems and methods are presented that secure the wiring harness to a collapsible harness substrate in a predefined pattern that coincides with the harness' packaging layout on the vehicle.

In an example, a foldable or rollable harness substrate system employs an insulated and protective substrate base having rollable, foldable, and/or flexible (collectively “bendable”) features that allow the substrate and wiring harness to be readily folded/rolled and unfolded/unrolled. The substrate base may include embedded channels for routing the cable segments of the harness, and holding features for securing select segments of the wiring harness in their respective “on vehicle” target assembly positions. The protective substrate base may take on various form factors, including a stiff tarp, a vehicle flooring carpet or similar material, a rollable cardboard panel, a foldable cardboard panel, etc. With the foregoing features, the collapsible harness substrate assembly may help to: (1) enable the compact packing and shipping of the wiring harness; (2) minimize pre-installation storage space requirements for the wiring harness; and (3) simplify and expedite the unfolding and aligning of the wiring harness at its designated vehicle-assembly positions.

Aspects of this disclosure are directed to collapsible harnesses substrate systems with integral holding features and/or embedded channels that cooperatively facilitate target positioning of electrical wiring harnesses. In an example, a wiring harness substrate system includes a wiring harness with multiple electrical connectors, multiple electrical cable segments that are electrically interconnected with the electrical connectors, and an assortment of optional junctions, relays, embedded sensors, ground couplers, etc. A collapsible harness substrate supports thereon the wiring harness, e.g., to optimize storage, shipping, unpacking, and installation of the harness onto a vehicle. Integrally formed with or attached to the harness substrate are a distributed array of holding features and a network of interconnected cable channels. The holding features releasably secure the electrical connectors and cable segments to the collapsible harness substrate, whereas the cable channels receive therein and route the cable segments across the harness substrate. The collapsible harness substrate is designed to be selectively transitioned, e.g., by a robot or operator, between an unfolded, unrolled, or opened (collectively “expanded”) state and a folded, rolled, or closed (collectively “packed”) state.

Additional aspects of this disclosure are directed to wiring harness substrates for target positioning of electrical wiring harnesses during assembly thereof onto motor vehicles. As used herein, the terms “vehicle” and “motor vehicle” may be used interchangeably and synonymously to include any relevant vehicle platform, such as passenger vehicles (ICE, HEV, FEV, fuel cell, fully and partially autonomous, etc.), commercial vehicles, industrial vehicles, tracked vehicles, off-road and all-terrain vehicles (ATV), motorcycles, farm equipment, aircraft, watercraft, spacecraft, e-bikes, etc. For non-automotive applications, disclosed harness substrate concepts may be implemented for any logically relevant use, including commercial and residential power stations, electric vehicle supply equipment, photovoltaic systems, pumping equipment, wind turbine farms, server systems, etc.

Continuing with the discussion of the foregoing example, a wiring harness substrate assembly includes a collapsible harness substrate that supports thereon a vehicle wiring harness. The collapsible harness substrate may include or, if desired, may consist essentially of an insulated and bendable panel. Multiple holding features are mounted on, integrally formed with, or otherwise attached to the collapsible harness substrate. Each holding feature releasably secures a respective electrical connector and/or cable segment of the wiring harness to the collapsible harness substrate. Multiple cable channels are mounted on, integrally formed with, or otherwise attached to the collapsible harness substrate. Each cable channel receives therein and routes a respective cable segment or segments of the wiring harness across the harness substrate. The cable channels may be arranged in a predefined routing pattern that coincides with a vehicle-specific routing pattern along which the vehicle wiring harness is mounted to the vehicle body/chassis. The collapsible harness substrate is structurally configured to be selectively bent from an expanded state to a packed state and, when desired, unbent from the packed state to the expanded state.

Further aspects of this disclosure are directed to manufacturing systems, workflow processes, and control logic for making or for using any of the herein described collapsible harness substrates, harnesses substrate systems, and/or motor vehicles. In an example, a method is presented for assembling a wiring harness support system, e.g., that helps to optimize the storage, shipping, unpacking, and installation of an electrical wiring harness. This representative method includes, in any order and in any combination with any of the above and below disclosed options and features: receiving a wiring harness with multiple electrical connectors and multiple electrical cable segments electrically interconnected with the electrical connectors; placing the wiring harness on a collapsible harness substrate, the collapsible harness substrate including multiple holding features and multiple cable channels; securing the electrical connectors to the collapsible harness substrate via the holding features; locating the electrical cable segments in the cable channels to thereby route the electrical cable segments across the collapsible harness substrate; and transitioning the collapsible harness substrate between an expanded state and a packed state.

For any of the disclosed wiring harness substrate systems, collapsible harness substrates, and methods, the collapsible harness substrate may be in the nature of an insulated and bendable substrate panel that, when in the expanded state, is substantially flat and elongated. In this instance, the substrate panel may be formed, in whole or in part, from a corrugated paper material, a fabric material, a carpet material, a polymeric tarp material, or other suitably flexible and non-conductive material. To facilitate collapsing and expanding the harness substrate, the substrate panel may be fabricated with multiple fold lines that are collectively arranged in a predefined pattern to enable the collapsible harness substrate to be selectively bent into and out of the packed state. Each fold line may be a rectilinear scored section, a rectilinear slotted section, and/or a rectilinear reduced-thickness section of the substrate panel.

For any of the disclosed wiring harness substrate systems, collapsible harness substrates, and methods, each holding feature may be a retention tab that is integrally formed with the collapsible harness substrate and wraps around a respective section of one of the electrical cable segments proximate one of the electrical connectors. It may be desirable that the cable channels be integrally formed with and recessed into the collapsible harness substrate. As a further option, a set of cable stiffeners may be attached to the collapsible harness substrate; each cable stiffener receives therethrough and structurally reinforces a respective section of one of the electrical cable segments. As noted above, the wiring harness may be a vehicle wiring harness for a motor vehicle; in this instance, the harness substrate's cable channels may be arranged in a predefined routing pattern that coincides with a vehicle-specific routing pattern in which the vehicle wiring harness is mounted to the vehicle body/chassis.

For any of the disclosed wiring harness substrate systems, collapsible harness substrates, and methods, the collapsible harness substrate may be substantially flat and have a cruciform plan-view profile when unfolded into the expanded state, and may be polyhedral with a box shape when folded into the packed state. Alternatively, the collapsible harness substrate may be substantially flat and have a polygonal plan-view profile when unfolded into the expanded state, and may be layered with a polygonal plan-view profile when folded into the packed state. As another option, the collapsible harness substrate includes multiple substrate panels each being substantially flat with a polygonal plan-view profile when unfolded into the expanded state, and each being polyhedral with a box shape when folded into the packed state. In at least some applications, the collapsible harness substrate may be rolled into a cylindrical form factor or hinged in a clamshell-type form factor when in the packed state.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a schematic illustration of a chassis underbody of a representative motor vehicle with an electrical wiring harness located on the vehicle chassis using a collapsible harness substrate assembly in accordance with aspects of the present disclosure.

FIGS. 2A and 2B are perspective-view and plan-view illustrations, respectively, of a representative foldable harness substrate assembly bearing an electrical wiring harness shown in a packed “boxed” state (FIG. 2A) and an expanded “unboxed” state (FIG. 2B) in accordance with aspects of the present disclosure.

FIGS. 3A-3D are a sequence of perspective-view and plan-view illustrations depicting another representative foldable harness substrate assembly bearing an electrical wiring harness shown in a packed “folded” state (FIG. 3A), a partially unfolded state (FIG. 3B), a mostly unfolded state (FIG. 3C), and an expanded “unfolded” state (FIG. 3D) in accordance with aspects of the present disclosure.

FIGS. 4A and 4B are perspective-view and plan-view illustrations, respectively, of yet another representative foldable harness substrate assembly bearing an electrical wiring harness shown in a packed “multi-boxed” state (FIG. 4A) and an expanded “unboxed” state (FIG. 4B) in accordance with aspects of the present disclosure.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for case of reference to similar features in the specification and drawings and to demarcate between similar elements in the claims.

For purposes of this disclosure, unless explicitly disclaimed: the singular includes the plural and vice versa (e.g., indefinite articles “a” and “an” are to be construed as meaning “one or more” unless expressly disclaimed); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

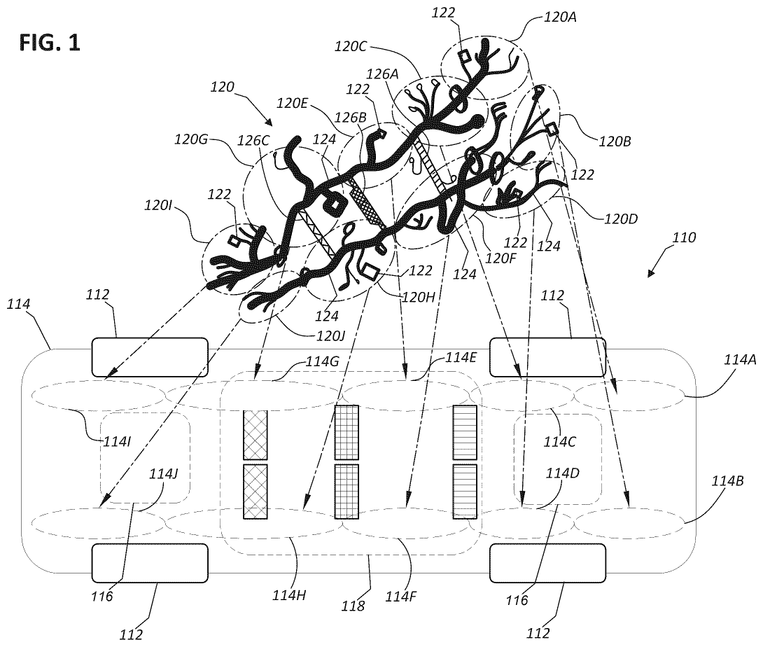

Referring now to the drawings, wherein like reference numbers refer to like features throughout the several views, there is shown in FIG. 1 a representative motor vehicle, which is designated generally at 110 and portrayed herein for purposes of discussion as a sedan-style, electric-drive automobile. The illustrated automobile 110—also referred to herein as “motor vehicle” or “vehicle” for short—is merely an exemplary application with which aspects of this disclosure may be practiced. In the same vein, utilization of the present concepts for the illustrated vehicle wiring harness should be appreciated as a non-limiting implementation of disclosed features. As such, it will be understood that aspects and features of this disclosure may be utilized for other wiring harness configurations, incorporated into any logically relevant type of motor vehicle, and utilized for both automotive and non-automotive applications alike. Moreover, only select components of the motor vehicles and wiring harness systems are shown and described in detail herein. Nevertheless, the vehicles and systems discussed below may include numerous additional and alternative features, and other available peripheral hardware, for carrying out the various methods and functions of this disclosure.

FIG. 1 illustrates the bottom-side “undercarriage” portion of the vehicle 110 in which a set of four road wheels 112 is shown operatively attached, e.g., via knuckles, spindles, control arms, struts, etc., to a vehicle chassis and body 114. The vehicle chassis/body 114 is a load-bearing and force-attenuating structure that may take on various architectures, including unibody, subframe, or body-on-frame chassis designs. To propel the vehicle 110, an electrified powertrain is operable to generate and deliver tractive torque to one or more of the vehicle's road wheels 112. The powertrain is represented in FIG. 1 by a dual-independent dual-drive (DIDU) powertrain layout with front-axle and rear-axle electric drive units (EDU) 116 that are supported on front and read motor cradles, respectively of the vehicle chassis/body 114. During vehicle operation, the EDUs 116 operate, both individually and collectively, to drive the road wheels 112 and thereby propel the vehicle 110. A rechargeable energy storage system (RESS), which may be in the nature of a chassis-mounted traction battery pack 118 containing an array of lithium-class battery cells, powers the EDUs 116 and an assortment of electrical loads on the vehicle 110. It is envisioned that disclosed concepts may be similarly implemented for full-electric vehicles (FEV), hybrid-electric vehicles (HEV), fuel-cell electric vehicles (FCEV), internal combustion engine (ICE) vehicles, and any other logically relevant vehicle type and vehicle powertrain configuration.

A high-voltage (HV) electrical systems governs the transfer of current between each EDU 116 and the traction battery pack 118 that supplies the requisite power for operating the electric-drive vehicle 110 of FIG. 1. In accord with the illustrated example, the resident HV electrical system is partially represented by a main-body wire harness (MBWH) 120 that is securely mounted to the vehicle chassis/body 114 and spans the fore-aft length of the vehicle 110 (e.g., from front headlights to rear tail lights). The wiring harness 120 may be typified by an assortment of electrical connectors (some of which are designated at 122) that are electrically interconnected with a network of electrical cable segments (some of which are designated at 124). Each electrical connector 122 may take on a variety of different connector configurations, including clip connectors, quick connectors, keyed connectors, pin connectors, terminal connectors, etc. The cable segments 124 may include electrically insulated sleeves that encase therein a bundle of individually insulated electrical wires, fiberoptic lines, multi-conductor (braided, ribbon, speaker) cables, etc. Once properly installed, the vehicle wiring harness 120 connects most/all of the electrical and electronic (E/E) components in the automobile 110, like sensors, electronic control units, actuators, accessories, and the like. It is envisioned that the wiring harness 120 may take on different architectures with greater or fewer electrical connectors 122 and/or cable segments 124 of similar or different types from what is shown in the Figures.

Wiring harness 120 may be apportioned into distinct zones that identify where each set of connectors 122 and cables 124 are to be placed on the vehicle chassis/body 114. As shown, the vehicle wiring harness 120 of FIG. 1 has ten (10) different zones: a front-right zone 120A; a front-left zone 120B; a front passenger-side zone 120C; a front driver-side zone 120D; a mid passenger-side zone 120E; a mid driver-side zone 120F; a rear passenger-side zone 120G; a rear driver-side zone 120H; a rear-right zone 1201; and a rear-left zone 120J. The vehicle wiring harness 120 may employ a series of cross-connect harness zones, such as forward cross-connect zone 126A, mid cross-connect zone 126B, and rear cross-connect zone 126C, that are marked or tagged with indica that identify each zone for proper alignment and mounting to corresponding target mounting points on the chassis/body 114. It should be appreciated that an electrical wiring harness may include any desired number and arrangement of zones without departing from the intended scope of this disclosure.

FIG. 1 schematically illustrates a representative assembly line mapping of the connectors 122 and cables 124 of the wiring harness 120 to their corresponding target mounting locations on the vehicle chassis/body 114. According to the illustrated example, the vehicle chassis/body 114 has ten (10) different target mounting points (also referred to as “receptacle areas”): a front-right mounting point 114A; a front-left mounting point 114B; a front passenger-side mounting point 114C; a front driver-side mounting point 114D; a mid passenger-side mounting point 114E; a mid driver-side mounting point 114F; a rear passenger-side mounting point 114G; a rear driver-side mounting point 114H; a rear-left mounting point 1141; and a rear-right mounting point 114J. Each wiring harness zone 120A-120J is aligned with and securely mounted to a respective one of the vehicle's target mounting points 114A-114J for proper installation of the wiring harness 120 on the motor vehicle 110.

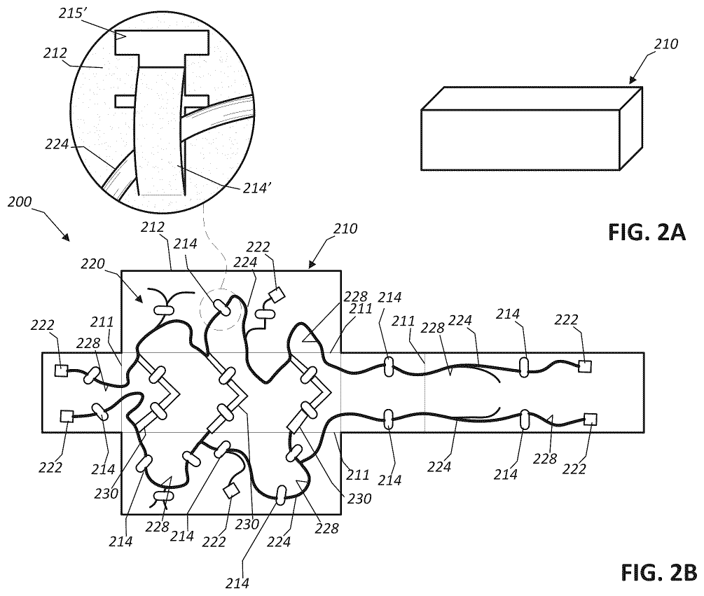

With reference next to FIGS. 2-4, there are shown three representative examples of collapsible harness substrate assemblies 210, 310 and 410, respectively, with integrated holding features and/or cable channels that cooperatively facilitate target positioning of electrical wiring harnesses. In each illustrated example, the collapsible harness substrate assembly 210, 310, 410 securely supports thereon an electrical wiring harness 220, 320 and 420, e.g., to optimize storage, shipping, unpacking, and installation of the harness into a vehicle or other manufactured product. Although differing in appearance, it is envisioned that the wiring harnesses 220, 320, 420 of FIGS. 2-4 may include any of the features and options described above with respect to the wiring harness 120 of FIG. 1, and vice versa. As a non-limiting point of similarity, each wiring harness 220, 320, 420 may be typified by a vehicle-specific set of electrical connectors 222 that are electrically interconnected with a network of electrical cable segments 224 and, depending on the desired application, an assortment of optional junctions, relays, embedded sensors, ground couplers, etc.

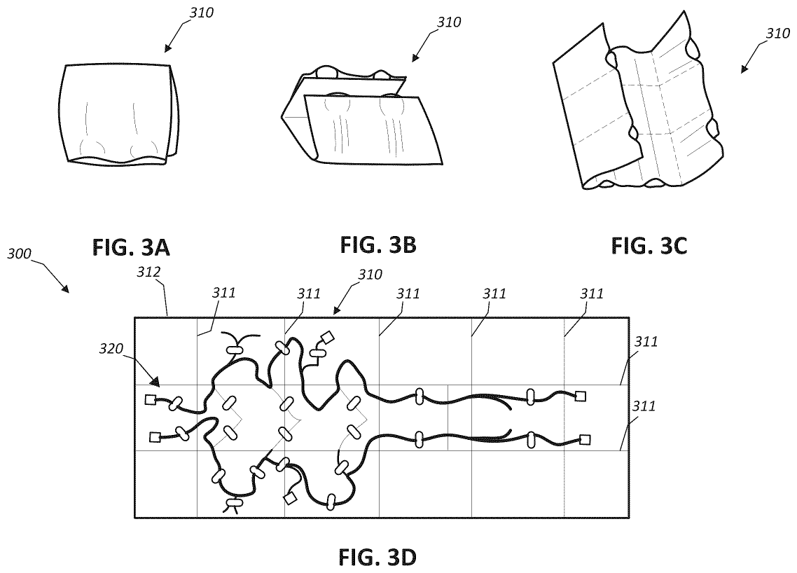

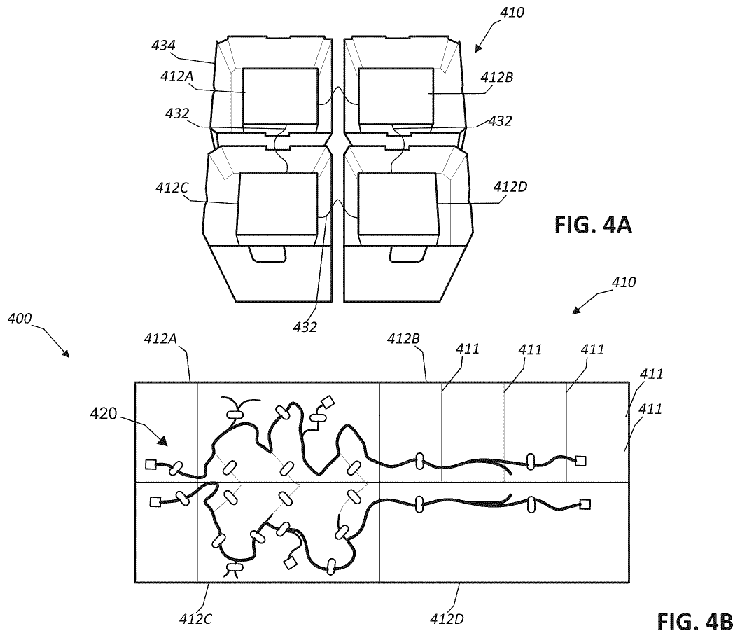

Each of the collapsible harness substrates assemblies 210, 310, 410 is illustrated as a single-piece insulated and bendable substrate panel 212 and 312 (FIGS. 2B and 3D) or multiple interconnected insulated and bendable substrate panels 412A-412D (FIG. 4B). While differing in appearance, it is envisioned that the substrate panels 312 and 412(A)-412(D) of FIGS. 3(D) and 4(B) may include any of the features and options described below with respect to the substrate panel 212 of FIG. 2(B), and vice versa. When expanded, for example, each substrate panel 212, 312, 412A-412D may be substantially flat and elongated with a polygonal plan-view profile. To protect and insulate the harness, the substrate panels 212, 312, 412A-412D may be formed, in whole or in part, from a corrugated paper material (e.g., cardboard), a fabric material (e.g., mesh-reinforced nylon), a carpet material (e.g., polyester tufts on latex backing), a polymeric tarp material (e.g., polypropylene canvas), or other suitably resilient substrate material. Each substrate panel 212, 312, 412A-412D may be fabricated with intersecting fold lines 211, 311 and 411 that are arranged in a predefined pattern to enable the collapsible harness substrate 210, 310, 410 to be manually or robotically bent, rolled, or otherwise folded into a desired packed state, examples of which are shown in FIGS. 2A, 3A and 4A. Each fold line 211, 311, 411 may be a rectilinear scored section, a rectilinear slotted section, and/or a rectilinear reduced-thickness section of the substrate panel 212, 312, 412A-412D. Alternatively, a substrate panel may include hinges, articulating joints, flaps, cutouts, etc., to enable the selective collapsing and expanding of the harness substrate assemblies 210, 310, 410.

To securely mount the harnesses 220, 320, 420, each substrate panel 212, 312, 412A-412D may incorporate a set of holding features (some of which are designated at 214 in FIG. 2B) that secure select electrical connectors 222 and select portions of the cable segments 224 to the harness substrate assemblies 210, 310, 410. The inset view of FIG. 2A portrays one of the holding features 214′ as a retention tab (e.g., hook or handle punchout) that is integrally formed with and projects from the substrate panel 212, 312, 412A-412D. As shown, the holding features 214′ is an arcuate flap that wraps around a respective section of a cable segments 224, proximate one of the electrical connectors 222, and secures inside a mating slot 215′ formed through the panel 212. Alternatively, the harness holding features 214 may comprise other mechanical attachment devices, such as rosebud clips, rivet fasteners, push-pin “Christmas tree” fasteners, etc. Once properly mounted, the harness substrate 210, 310, 410 and wiring harness 220, 320, 420 may collectively define a wiring harness substrate system 200, 300 and 400, respectively, that compactly holds the harness 220, 320, 420 for storage and transport prior to assembly on a vehicle, while also facilitating rapid unpacking and routing of the harness on the assembly line.

To help optimize “in-line” harnesses positioning with predefined “on vehicle” target mounting locations, the substrate panels 212, 312, 412A-412D may be fabricated with embedded cable channels (some of which are designated at 228 in FIG. 2B) that receive therein and route the cable segments 224 across the width and length of the harness substrate assemblies 210, 310, 410. For simplicity of design and ease of manufacture, these cable channels 228 may be integrally formed with and recessed into the harness-supporting top surface of the substrate panel 212, 312, 412A-412D. To facilitate harness positioning, the cable channels 228 may be arranged (i.e., surface mapped) in a predefined routing pattern that coincides with a vehicle-specific routing pattern in which the wiring harness 220, 320, 420 will be mounted to a vehicle (e.g., vehicle body/chassis 114 of FIG. 1). For at least some applications, the harness substrate assemblies 210, 310, 410 may include labels on the substrate panels 212, 312, 412A-412D that identify the various sections of the harness 220, 320, 420 (e.g., harness zones 120A-120J of FIG. 1) and/or their respective on-vehicle mounting locations (e.g., target mounting points 114A-114J). In the same vein, a machine-readable code (e.g., barcode or quick-reference (QR) code) may be added to the substrate panels 212, 312, 412A-412D to identify the harness 220, 320, 420 and information related thereto. As yet a further option, the harness substrate assemblies 210, 310, 410 may employ rigid cable stiffeners 230 (FIG. 2B) that attach to the substrate panels 212, 312, 412A-412D; each cable stiffener 230 receives therethrough and structurally reinforces a respective section of one of the cable segments 224.

To simplify and expedite the storage, shipping, and unpacking of the harness 220, 320, 420, each collapsible harness substrate assembly 210, 310, 410 is designed to be selectively transitioned, e.g., by a robot, operator, mechanic, etc., from an unfolded, unrolled, or opened state (collectively “expanded state”) to a folded, rolled, or closed state (collectively “packed state”). By way of example, and not limitation, the collapsible harness substrate 210 and wiring harness 220 may be bent and secured closed in the folded state shown in FIG. 2A (e.g., at a supplier plant) and, when desired, opened and expanded to the unfolded state shown in FIG. 2B (e.g., at an OEM plant). When in the folded state, the substrate 212 may take on a rectangular-prism box shape; conversely, when in the unfolded state, the substrate 212 may be substantially flat with a cruciform plan-view profile. Comparatively, the collapsible harness substrate 310 and wiring harness 320 may be bent into a folded state (FIG. 3A) and, when desired, progressively unfolded through various unfolding stages (FIGS. 3B and 3C) to an unfolded state (FIG. 3D). The substrate 312, when folded, may be substantially flat with a rectangular plan-view profile; when unfolded, the substrate 312 may be layered with a square plan-view profile. The collapsible harness substrate assembly 410 of FIGS. 4A and 4B, in contrast, includes multiple substrate panels 412A-412D that are constructed into “nested” boxes (FIG. 4A) that are bound together via tethers 432 and packaged inside a protective outer box 434. Each substrate panel 412A-412D may take on a square-prism box shape when in the packed state (FIG. 4A); when in the expanded state (FIG. 4B), each panel 412A-412D may be substantially flat with a rectangular plan-view profile.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A wiring harness substrate system, comprising:
a wiring harness including multiple electrical connectors and multiple electrical cable segments electrically interconnected with the electrical connectors; and
a collapsible harness substrate supporting thereon the wiring harness, the harness substrate including multiple holding features and multiple cable channels, the holding features securing the electrical connectors to the harness substrate, and the cable channels receiving therein and routing the electrical cable segments across the harness substrate, wherein the harness substrate is configured to be selectively transitioned between an expanded state and a packed state.

2. The wiring harness substrate system of claim 1, wherein the collapsible harness substrate includes an insulated and bendable substrate panel that, when in the expanded state, is substantially flat and elongated.

3. The wiring harness substrate system of claim 2, wherein the substrate panel is formed with a corrugated paper material, a fabric material, a carpet material, and/or a polymeric tarp material.

4. The wiring harness substrate system of claim 2, wherein the substrate panel includes multiple fold lines collectively arranged in a predefined pattern to enable the collapsible harness substrate to be selectively bent into the packed state.

5. The wiring harness substrate system of claim 4, wherein each of the fold lines includes a rectilinear scored section, a rectilinear slotted section, or a rectilinear reduced-thickness section of the substrate panel.

6. The wiring harness substrate system of claim 1, wherein each of the holding features includes a retention tab integrally formed with the collapsible harness substrate and wrapped around a respective section of one of the electrical cable segments proximate one of the electrical connectors.

7. The wiring harness substrate system of claim 1, further comprising multiple cable stiffeners attached to the collapsible harness substrate, each of the cable stiffeners receiving therethrough and structurally reinforcing a respective section of one of the electrical cable segments.

8. The wiring harness substrate system of claim 1, wherein the cable channels are integrally formed with and recessed into the collapsible harness substrate.

9. The wiring harness substrate system of claim 1, wherein the wiring harness is a vehicle wiring harness for a motor vehicle with a vehicle body/chassis, and wherein the cable channels are arranged in a predefined routing pattern coinciding with a vehicle-specific routing pattern in which the vehicle wiring harness is mounted to the vehicle body/chassis.

10. The wiring harness substrate system of claim 1, wherein the collapsible harness substrate is substantially flat and has a cruciform plan-view profile when in the expanded state, and is polyhedral with a box shape when in the packed state.

11. The wiring harness substrate system of claim 1, wherein the collapsible harness substrate is substantially flat and has a polygonal plan-view profile when in the expanded state, and is layered with a polygonal plan-view profile when in the packed state.

12. The wiring harness substrate system of claim 1, wherein the collapsible harness substrate includes multiple substrate panels each being substantially flat with a polygonal plan-view profile when in the expanded state, and each being polyhedral with a box shape when in the packed state.

13. A wiring harness substrate assembly for locating a wiring harness on a motor vehicle, the motor vehicle including a vehicle body/chassis, and the wiring harness including multiple electrical connectors and multiple electrical cable segments electrically connected with the electrical connectors, the wiring harness substrate assembly comprising:
a collapsible harness substrate supporting thereon the wiring harness, the collapsible harness substrate including an insulated and bendable panel;
a plurality of holding features attached to the collapsible harness substrate and each configured to releasably secure a respective one of the electrical connectors of the wiring harness to the collapsible harness substrate; and
a plurality of cable channels on the collapsible harness substrate and each configured to receive therein and route a respective one of the electrical cable segments of the wiring harness across the collapsible harness substrate, the cable channels are arranged in a predefined routing pattern coinciding with a vehicle-specific routing pattern along which the vehicle wiring harness is mounted to the vehicle body/chassis,
wherein the collapsible harness substrate is configured to be selectively bent from an expanded state to a packed state and unbent from the packed state to the expanded state.

14. A method of assembling a wiring harness support system, the method comprising:
receiving a wiring harness with multiple electrical connectors and multiple electrical cable segments electrically interconnected with the electrical connectors;
placing the wiring harness on a collapsible harness substrate, the collapsible harness substrate including multiple holding features and multiple cable channels;
securing the electrical connectors to the collapsible harness substrate via the holding features;
locating the electrical cable segments in the cable channels to thereby route the electrical cable segments across the collapsible harness substrate; and
transitioning the collapsible harness substrate between an expanded state and a packed state.

15. The method of claim 14, wherein the collapsible harness substrate includes an insulated and bendable substrate panel that, when in the expanded state, is substantially flat and elongated.

16. The method of claim 15, wherein the substrate panel includes multiple fold lines collectively arranged in a predefined pattern to enable the collapsible harness substrate to be selectively bent into the packed state.

17. The method of claim 14, wherein each of the holding features includes a retention tab integrally formed with the collapsible harness substrate and wrapped around a respective section of one of the electrical cable segments proximate one of the electrical connectors.

18. The method of claim 14, further comprising:
attaching a plurality of cable stiffeners to the collapsible harness substrate; and
passing a respective section of one of the electrical cable segments through each of the cable stiffeners.

19. The method of claim 14, wherein the cable channels are integrally formed with and recessed into the collapsible harness substrate.

20. The method of claim 14, wherein the wiring harness is a vehicle wiring harness for a motor vehicle with a vehicle body/chassis, and wherein the cable channels are arranged in a predefined routing pattern coinciding with a vehicle-specific routing pattern in which the vehicle wiring harness is mounted to the vehicle body/chassis.
